(19) United States
(12) Patent Application Publication
(10) Pub. No.: US 2026/0178146 A1
(43) Pub. Date: Jun. 25, 2026

(54) CALIBRATION METHOD AND COORDINATE CONVERSION TOOL

(71) Applicant: Wacom Co., Ltd., Saitama (JP)

(72) Inventor: Futa IMATA, Saitama (JP)

(73) Assignee: Wacom Co., Ltd., Saitama (JP)

(21) Appl. No.: 19/540,067

(22) Filed: Feb. 13, 2026

Related U.S. Application Data
(63) Continuation of application No. PCT/JP2024/029471, filed on Aug. 20, 2024.

(30) Foreign Application Priority Data
Sep. 14, 2023 (JP) 2023-149660

(51) Int. Cl. G06F 3/041; G06F 3/01; G06F 3/0346; G06F 3/0354; G06F 3/046

(52) U.S. Cl. CPC G06F 3/0418; G06F 3/011; G06F 3/0346; G06F 3/03545; G06F 3/046

(57) ABSTRACT

Provided is a calibration method performed by a computer, the method including, by the computer, calculating, on the basis of a position and an attitude of a coordinate transformation tool included in an image captured of the coordinate transformation tool located on a surface of an apparatus including a digitizer, a transformation rule for performing coordinate transformation processing that transforms first coordinates specifying a position, on the surface, indicated by a stylus into second coordinates specifying a position in an extended reality space.

### BACKGROUND

### Technical Field

The present disclosure relates to a calibration method and a coordinate transformation tool, and particularly, to a calibration method for handling a pen input performed on a tablet terminal as an object in an extended reality (XR) space, and a coordinate transformation tool for implementing the calibration method.

### Description of the Related Art

In an existing XR technology, a user operates a three-dimensional (3D) controller in the air. PCT Patent Publication No. WO2019/102825 (hereinafter, referred to as Patent Document 1) discloses a technology that enables a 3D object to be edited by using a tablet terminal. In this technology, a tracker is disposed on the tablet terminal. On the basis of the position and orientation of the tracker in a real space, the position and attitude of the tablet terminal in the real space are detected.

However, with the technology described in the foregoing Patent Document 1, it is not easy to use the tablet terminal in the XR technology.

### BRIEF SUMMARY

According to various embodiments, a calibration method and a coordinate transformation tool that enable a tablet terminal to be used with ease in the XR technology.

A calibration method according to one aspect of the present disclosure is a calibration method performed by a computer, the method including, by the computer, calculating, on the basis of a position and an attitude of a coordinate transformation tool included in an image captured of the coordinate transformation tool located on a surface of an apparatus including a digitizer, a transformation rule for performing coordinate transformation processing. The transformation rule transforms first coordinates specifying a position, on the surface and indicated by a stylus, into second coordinates specifying a position in an XR space.

A coordinate transformation tool according to one aspect of the present disclosure is a coordinate transformation tool for use by a computer, the coordinate transformation tool including a two-dimensional code. The computer is configured to calculate, on the basis of a position and a shape of the two-dimensional code included in an image captured of the coordinate transformation tool fixed to a surface of an apparatus including a digitizer, a transformation rule for performing coordinate transformation processing. The transformation rule transforms first coordinates specifying a position, on the surface and indicated by a stylus, into second coordinates specifying a position in an XR space.

A calibration method according to another aspect of the present disclosure is a calibration method performed by a computer, the method including, by the computer, receiving information indicating a position and an attitude of a coordinate transformation tool with respect to a surface of an apparatus including a digitizer and calculating a transformation rule for performing coordinate transformation processing that transforms first coordinates specifying a position, on the surface and indicated by a stylus, into second coordinates specifying a position in an XR space. The calculation is on the basis of the received information indicating the position and the attitude of the coordinate transformation tool with respect to the surface and a position and an attitude of the coordinate transformation tool in the XR space.

A calibration method according to another aspect of the present disclosure may be a calibration method performed by a computer, the method including, by the computer, receiving coordinates indicating a display position of a coordinate transformation tool on a surface of an apparatus including a digitizer and calculating a transformation rule for performing coordinate transformation processing that transforms first coordinates specifying a position, on the surface and indicated by a stylus, into second coordinates specifying a position in an XR space. The calculation is on the basis of the received coordinates indicating the display position of the coordinate transformation tool on the surface and a position and an attitude of the coordinate transformation tool in the XR space.

A coordinate transformation tool according to another aspect of the present disclosure is a coordinate transformation tool for use by a computer, the coordinate transformation tool including a position indicator configured to enable an apparatus including a digitizer to detect a position and an attitude of the position indicator with respect to a surface of the apparatus. The computer is configured to calculate a transformation rule for performing coordinate transformation processing on the basis of the position and the attitude of the position indicator with respect to the surface that are detected by the apparatus including the digitizer.

A coordinate transformation tool according to another aspect of the present disclosure may be a coordinate transformation tool for use by a computer, the coordinate transformation tool including an image displayed on a surface of an apparatus including a digitizer. The computer is configured to obtain a transformation rule for performing coordinate transformation processing that transforms first coordinates specifying a position, on the surface and indicated by a stylus, into second coordinates specifying a position in an XR space on the basis of coordinates indicating a display position of the image displayed on the surface.

According to the present disclosure, it is possible to use a tablet terminal with ease in the XR technology.

### BRIEF DESCRIPTION OF THE SEVERAL VIEWS OF THE DRAWINGS

FIG. 1 is a diagram illustrating an XR system according to a first embodiment of the present disclosure;

FIG. 2 is a top view of a tablet terminal;

FIG. 3 is a sequence diagram illustrating a process for a computer to obtain a transformation rule for mutually transforming a tablet surface coordinate system and a virtual reality space coordinate system;

FIG. 4 is a sequence diagram illustrating a process in which the computer that has obtained the transformation rule displays a result of pen input performed on the tablet terminal, as an object in an XR space;

FIG. 5 is a sequence diagram illustrating a process for updating as needed the transformation rule obtained by the process of FIG. 3;

FIG. 6A is a top view of a coordinate transformation tool according to a modification of the first embodiment of the present disclosure, and FIG. 6B is a side view of the coordinate transformation tool according to the modification of the first embodiment of the present disclosure;

FIG. 7A is a top view of the tablet terminal and a coordinate transformation tool according to a second embodiment of the present disclosure, and FIG. 7B is a side view of the tablet terminal and the coordinate transformation tool according to the second embodiment of the present disclosure;

FIG. 8 is a sequence diagram illustrating a process for the computer to obtain the transformation rule for mutually transforming the tablet surface coordinate system and the virtual reality space coordinate system;

FIG. 9A is a top view of the tablet terminal and a coordinate transformation tool according to a first modification of the second embodiment of the present disclosure, and FIG. 9B is a side view of the tablet terminal and the coordinate transformation tool according to the first modification of the second embodiment of the present disclosure;

FIG. 10A is a top view of the tablet terminal and a coordinate transformation tool according to a second modification of the second embodiment of the present disclosure, and FIG. 10B is a side view of the tablet terminal and the coordinate transformation tool according to the second modification of the second embodiment of the present disclosure;

FIG. 11 is a top view of the tablet terminal and a coordinate transformation tool according to a third embodiment of the present disclosure; and

FIG. 12 is a sequence diagram illustrating a process for the computer to obtain the transformation rule for mutually transforming the tablet surface coordinate system and the virtual reality space coordinate system.

### DETAILED DESCRIPTION

Embodiments of the present disclosure will hereinafter be described in detail with reference to the accompanying drawings.

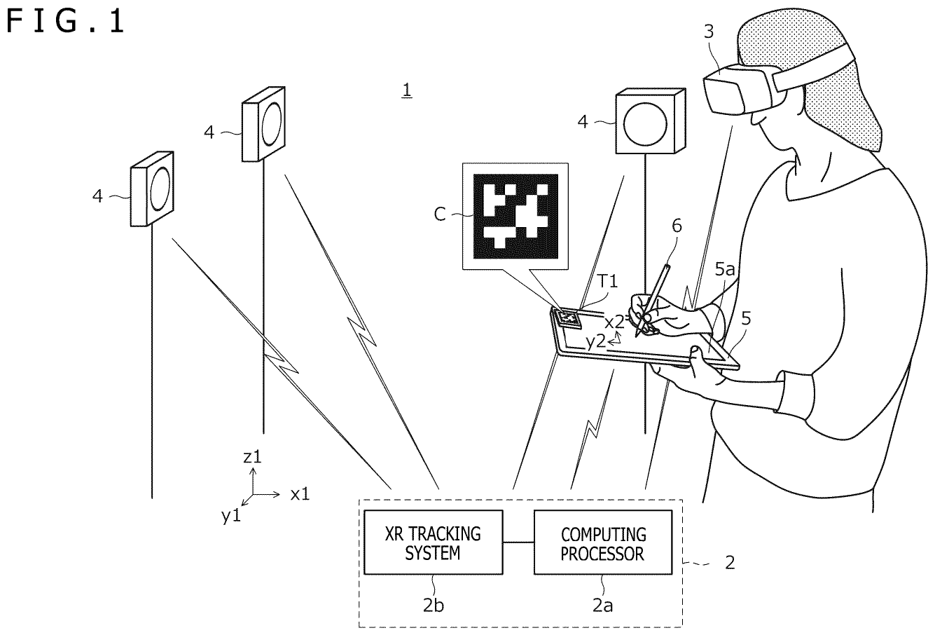

FIG. 1 is a diagram illustrating an XR system 1 according to a first embodiment of the present disclosure. As illustrated in FIG. 1, the XR system 1 according to the present embodiment includes a computer 2, a virtual reality display 3, a plurality of cameras 4, a tablet terminal 5, a pen 6, and a coordinate transformation tool T1. Of these, the computer 2 includes, as functional sections, a computing processor 2a and an XR tracking system 2b. Incidentally, the computer 2 may be a single computer or may be a multi-computer that consists of a combination of a plurality of computers and functions as a single computer. In addition, a two-dimensional code C (to be described later) indicated by a callout in FIG. 1 is disposed on the top surface of the coordinate transformation tool T1.

The computer 2 is an apparatus including a processor, a memory, and a communication device. The processor implements various functions of the computer 2 including the computing processor 2a and the XR tracking system 2b illustrated in FIG. 1, by executing a program stored in the memory. The communication device is configured to perform mutual communication with each of the virtual reality display 3, the plurality of cameras 4, and the tablet terminal 5 in a wired or wireless manner under the control of the processor.

The computing processor 2a is a functional section that has functions of setting an XR space with the positions of the plurality of cameras 4 as a reference, generating an image representing the set XR space, and supplying the image to the virtual reality display 3. An x1 axis, a y1 axis, and a z1 axis illustrated in FIG. 1 represent a virtual reality space coordinate system that defines the XR space set by the computing processor 2a. The position and attitude of each of various objects that the computing processor 2a displays in the XR space are represented by a six-dimensional vector (an x1 coordinate, a y1 coordinate, a z1 coordinate, an amount of rotation about the x1 axis, an amount of rotation about the y1 axis, and an amount of rotation about the z1 axis) in the virtual reality space coordinate system.

The virtual reality display 3 is an XR display (head-mounted display) that is used while mounted on the head of a person. There are various types of commercially available virtual reality displays such as a “transmissive type,” a “non-transmissive type,” an “eyeglass type,” and a “headgear type.” Any of these types can be used as the virtual reality display 3. In a case where the XR space set by the computing processor 2a is a virtual reality (VR) space, a user wearing the virtual reality display 3 recognizes virtual reality and is detached from a real world. In a case where the XR space set by the computing processor 2a is an augmented reality (AR) space or an mixed reality (MR) space, on the other hand, the user wearing the virtual reality display 3 recognizes a space in which virtual reality and the real world are mixed with each other.

The computing processor 2a also performs processing of rendering various 3D objects and arranging the 3D objects in the image. The 3D objects as targets of the rendering can include 3D objects existing also in reality, such as the tablet terminal 5 illustrated in FIG. 1, and 3D objects not existing in reality. As a result of the processing by the computing processor 2a, the user wearing the virtual reality display 3 can visually recognize the 3D objects in the XR space.

The computing processor 2a performs the rendering on the basis of 3D object information stored in the memory. The 3D object information is information indicating the shape, position, and attitude of a 3D object in the XR space set by the computing processor 2a. The 3D object information is stored in the memory for each of the 3D objects to be rendered.

In generating an image representing the XR space, the computing processor 2a first obtains the position and attitude of the virtual reality display 3. Specifically, it is sufficient to receive the position and attitude of the virtual reality display 3 from the XR tracking system 2b to be described later. The computing processor 2a determines the viewpoint of the user on the basis of the obtained position and attitude of the virtual reality display 3 and performs the rendering of the 3D objects and the generation of the image representing the XR space on the basis of the determined viewpoint. Thus, the user viewing the XR space through the virtual reality display 3 can view each of the 3D objects at the same position as an actual position thereof.

The XR tracking system 2b is a functional section that has functions of detecting an object (that is an object existing in reality and includes the virtual reality display 3) included in an image captured by each of the plurality of cameras 4 and tracking the position and attitude of the object. The plurality of cameras 4 are arranged so as to be able to image, from various angles, different positions in a real space corresponding to the XR space set by the computing processor 2a. While three cameras 4 are illustrated in FIG. 1, more cameras 4 can be actually arranged.

The XR tracking system 2b detects an object by detecting an optical marker added to the object (any kind of marker can be used as long as it is optically detectable) or performing image recognition of the object. The result of the tracking by the XR tracking system 2b is sequentially stored as part of the above-described 3D object information into the memory of the computing processor 2a. The computing processor 2a performs the rendering of the 3D objects existing in reality on the basis of the tracking result thus stored in the memory.

The tablet terminal 5 is an apparatus (computer) having a flat tablet surface 5a and includes a digitizer that detects the position of a position indicator on the tablet surface 5a. The tablet surface 5a serves as both an input surface for receiving pen input and a display surface for displaying video. The tablet terminal 5 is configured to be able to display, on the tablet surface 5a, various kinds of data including stroke data (to be described later) obtained as a result of the pen input. Incidentally, in the present embodiment and a second embodiment to be described later, a tablet terminal 5 of a type whose tablet surface 5a does not function as the display surface can alternatively be used.

The pen 6 is an electronic pen (stylus) having a shape like a pen and serves as a position indicator. The user performs input (pen input) to the tablet terminal 5 by sliding a pen tip of the pen 6 on the tablet surface 5a. A system of the pen input is not particularly limited, and an electro-magnetic resonance (EMR) system or an active capacitive system, for example, can suitably be used for the pen input. In addition, the tablet terminal 5 may also support input from a finger (touch input). As a concrete system of the touch input, a capacitive system may be adopted, for example.

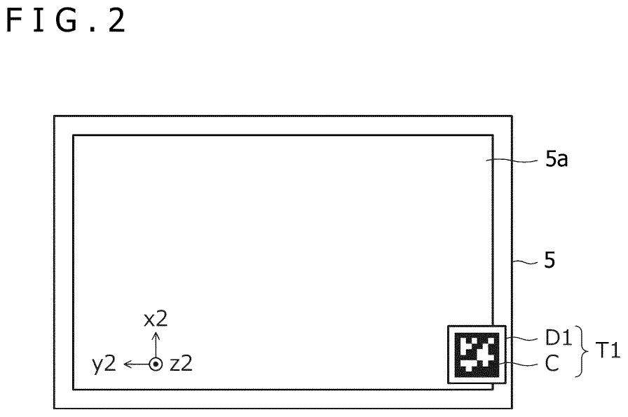

The tablet terminal 5 has a function of sequentially detecting the position of the pen 6 on the tablet surface 5a. An x2 axis and a y2 axis illustrated in FIG. 2 represent a plane coordinate system that defines a position on the tablet surface 5a. The position of the pen 6 detected by the tablet terminal 5 is represented by coordinates in the plane coordinate system.

Here, concrete configuration and processing for implementing the pen input will be described by taking the EMR system and the active capacitive system as examples. First, a case of using the EMR system is described. The tablet terminal 5 that supports the EMR system includes a plurality of loop coils each extending in an x2-axis direction and a plurality of loop coils each extending in a y2-axis direction. In addition, the pen 6 that supports the EMR system includes an LC resonant circuit including a coil and a capacitor connected in series with each other. The tablet terminal 5 intermittently sends out an alternating magnetic field from the tablet surface 5a by supplying an alternating current to any one of the loop coils. When the coil of the pen 6 enters the alternating magnetic field, the capacitor of the pen 6 is charged. When the sending out of the alternating magnetic field by the tablet terminal 5 is ended, an alternating magnetic field as a reflection signal is sent out from the coil of the pen 6 due to the power stored in the capacitor. The tablet terminal 5 attempts to detect the alternating magnetic field at each of the above-described loop coils and detects the position of the pen 6 on the tablet surface 5a on the basis of a distribution of strength of the detected alternating magnetic field.

Next, a case of using the active capacitive system is described. The tablet terminal 5 that supports the active capacitive system includes a plurality of linear electrodes each extending in the x2-axis direction and a plurality of linear electrodes each extending in the y2-axis direction. In addition, the pen 6 that supports the active capacitive system includes a pen tip electrode provided to the pen tip thereof, a processing circuit connected to the pen tip electrode, and a battery that supplies power to the processing circuit. The tablet terminal 5 transmits an uplink signal from the tablet surface 5a by supplying a signal to any one of the linear electrodes. When receiving the uplink signal via the pen tip electrode, the processing circuit of the pen 6 generates a downlink signal as a response signal and transmits the downlink signal from the pen tip electrode to the tablet surface 5a. The tablet terminal 5 attempts to detect the downlink signal at each of the above-described linear electrodes and detects the position of the pen 6 on the tablet surface 5a on the basis of a distribution of strength of the detected downlink signal.

The tablet terminal 5 also has a function of obtaining various kinds of data from the pen 6. This data can include a pen pressure value indicating a pressure applied to the pen tip, on/off information indicating an on/off state of a switch provided to a casing of the pen 6, and a pen identification (ID) as identification information of the pen 6. The pen 6 transmits these pieces of data by modulating the alternating magnetic field or the downlink signal described above. The tablet terminal 5 obtains the data transmitted by the pen 6, by demodulating the received alternating magnetic field or downlink signal.

The tablet terminal 5 performs processing of generating stroke data representing the trajectory of the pen tip, on the basis of the position of the pen 6 obtained as described above and the various kinds of data received from the pen 6. The stroke data is data represented by a series of pieces of coordinate data. Each piece of coordinate data can include not only plane coordinates indicating the position on the tablet surface but also the pen pressure value and the on/off information described above. The tablet terminal 5 performs processing of storing the generated stroke data and displaying the stroke data on the tablet surface 5a.

In addition, each time the tablet terminal 5 detects the position of the pen 6, the tablet terminal 5 also performs processing of supplying plane coordinates indicating the detected position to the computing processor 2a. The computing processor 2a performs coordinate transformation processing of transforming the plane coordinates received from the tablet terminal 5, into coordinates in the virtual reality space coordinate system. Then, the computing processor 2a performs processing of storing the stroke data that has undergone the transformation, as one piece of the above-described 3D object information in the memory, and rendering and disposing the stroke data in the XR space. The user can thereby visually recognize the stroke data generated according to the pen input, as a 3D object in the XR space.

FIG. 2 is a top view of the tablet terminal 5. As illustrated in FIG. 2, the user affixes the coordinate transformation tool T1 to the top surface of the tablet terminal 5 at a known position in a known orientation. Here, “at a known position in a known orientation” means that the computer 2 stores the position and attitude of the coordinate transformation tool T1 with respect to the tablet surface 5a in advance. The computer 2 stores the position and attitude of the coordinate transformation tool T1 with respect to the tablet surface 5a by using a six-dimensional vector (an x2 coordinate, a y2 coordinate, a z2 coordinate, an amount of rotation about the x2 axis, an amount of rotation about the y2 axis, and an amount of rotation about a z2 axis that extends in a direction normal to the tablet surface 5a) in a 3D coordinate system (tablet surface coordinate system) having the z2 axis in addition to the x2 axis and the y2 axis on the tablet surface 5a.

As illustrated in FIG. 2, the coordinate transformation tool T1 includes a box-shaped casing D1 and a two-dimensional code C that is disposed on the top surface of the casing D1. The two-dimensional code C is a kind of optical marker described above and is generated on the basis of identification information of the coordinate transformation tool T1, for example. In a typical example, the two-dimensional code C is printed on the upper surface of the casing D1.

Reference is made to FIG. 1 again. In order to perform the coordinate transformation processing described above, the computer 2 performs a process (calibration) of obtaining a transformation rule for mutually transforming the tablet surface coordinate system and the virtual reality space coordinate system, by using the coordinate transformation tool T1. This process will be described in detail in the following.

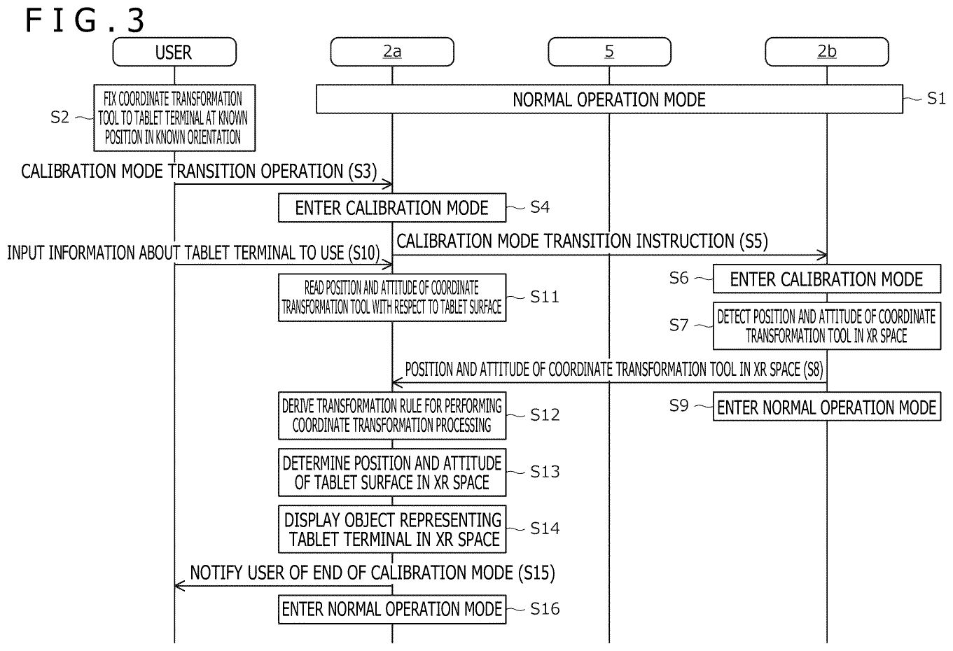

FIG. 3 is a sequence diagram illustrating the process for the computer 2 to obtain the transformation rule described above. As illustrated in FIG. 3, in an initial state, the computing processor 2a, the tablet terminal 5, and the XR tracking system 2b are each operating in a normal operation mode (step S1). Specifically, the XR tracking system 2b is performing processing of detecting an object included in an image captured by each of the plurality of cameras 4, tracking the position and attitude of the object, and sequentially storing the result as part of 3D object information in the memory of the computer 2. In addition, the computing processor 2a is performing processing of generating an image representing the XR space including a result of rendering of various 3D objects, and supplying the image to the virtual reality display 3. The tablet terminal 5 is performing processing of generating stroke data representing the trajectory of the pen 6 on the tablet surface 5a, displaying the stroke data on the display surface, and sequentially supplying the detected position of the pen 6 to the computer 2.

The user fixes the coordinate transformation tool T1 to the tablet terminal 5 at a known position in a known orientation (step S2) and thereafter performs a predetermined operation for causing the computing processor 2a to make a transition to a calibration mode (mode for performing calibration) (step S3). This operation may be performed by the computer 2 or may instead be performed by the tablet terminal 5. When receiving the operation performed in step S3, the computing processor 2a enters the calibration mode (step S4) and transmits a calibration mode transition instruction to the XR tracking system 2b (step S5).

When receiving the calibration mode transition instruction from the computing processor 2a, the XR tracking system 2b enters the calibration mode (step S6) and detects the position and attitude of the coordinate transformation tool T1 in the XR space (step S7). This detection is performed on the basis of the position and shape of the two-dimensional code C included in the images captured by the plurality of cameras 4. The XR tracking system 2b transmits a six-dimensional vector in the virtual reality space coordinate system which indicates the detected position and attitude, to the computing processor 2a (step S8), and returns to the normal operation mode (step S9).

The user also inputs information about the tablet terminal 5 to use to the computer 2 (step S10). While FIG. 3 depicts step S10 after step S3, step S10 may be performed before steps S2 and S3. When receiving the input of the information, the computing processor 2a reads a six-dimensional vector in the tablet surface coordinate system which indicates the position and attitude (position and attitude with respect to the tablet surface 5a) of the coordinate transformation tool T1 stored in advance for the relevant tablet terminal 5, from the memory of the computer 2 (step S11).

The computing processor 2a next calculates a transformation rule for mutually transforming the tablet surface coordinate system and the virtual reality space coordinate system, on the basis of the position and attitude of the coordinate transformation tool T1 which are read in step S11 and the position and attitude of the coordinate transformation tool T1 in the XR space which are received in step S8 (step S12). Specifically, it is sufficient to calculate a rotation matrix for transforming the six-dimensional vector read in step S11 into the six-dimensional vector received in step S8 and obtain the rotation matrix as the transformation rule.

In addition, the computing processor 2a determines the position and attitude of the tablet surface 5a in the XR space on the basis of the position and attitude of the coordinate transformation tool T1 with respect to the tablet surface 5a which are read in step S11 and the position and attitude of the coordinate transformation tool T1 in the XR space which are received in step S8 (step S13). Then, the computing processor 2a displays an object representing the tablet terminal 5 in the XR space on the basis of the position and attitude of the tablet surface 5a determined in step S13 (step S14).

Thereafter, the computing processor 2a notifies the user of an end of the calibration mode (step S15) and returns to the normal operation mode (step S16). A notification method in step S15 is not particularly limited, and any of various methods including, for example, display and sound notification can be adopted.

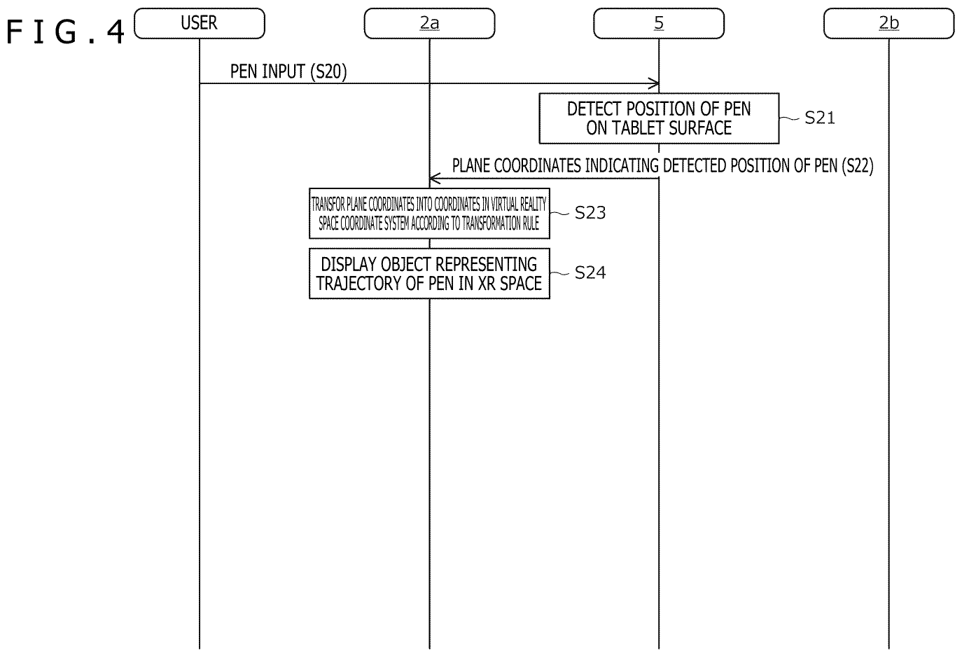

FIG. 4 is a sequence diagram illustrating a process in which the computer 2 that has obtained the transformation rule displays a result of pen input performed on the tablet terminal 5, as an object in the XR space. The process illustrated in FIG. 4 is performed each time the tablet terminal 5 detects the position of the pen 6. As illustrated in FIG. 4, when the user performs pen input (step S20), the tablet terminal 5 detects the position of the pen 6 on the tablet surface 5a as a result of the pen input (step S21) and transmits plane coordinates indicating the detected position of the pen to the computing processor 2a (step S22).

When receiving the plane coordinates indicating the position of the pen from the tablet terminal 5, the computing processor 2a performs the coordinate transformation processing of transforming the received plane coordinates into coordinates in the virtual reality space coordinate system (six-dimensional vector in the virtual reality space coordinate system), by using the transformation rule calculated in step S12 in FIG. 3 (step S23). At this time, it is sufficient if the computing processor 2a generates a six-dimensional vector in the tablet surface coordinate system by adding zero as the value of each of a z2 coordinate, an amount of rotation about the x2 axis, an amount of rotation about the y2 axis, and an amount of rotation about the z2 axis to the plane coordinates (two-dimensional vector) indicating the position of the pen, and applies the transformation rule to the generated six-dimensional vector to calculate the six-dimensional vector in the virtual reality space coordinate system. The computing processor 2a displays an object representing the trajectory of the pen 6 in the XR space by using the coordinates obtained by the transformation in step S23 (step S24). The user can thereby visually recognize the result of the pen input performed on the tablet terminal 5, as an object in the XR space.

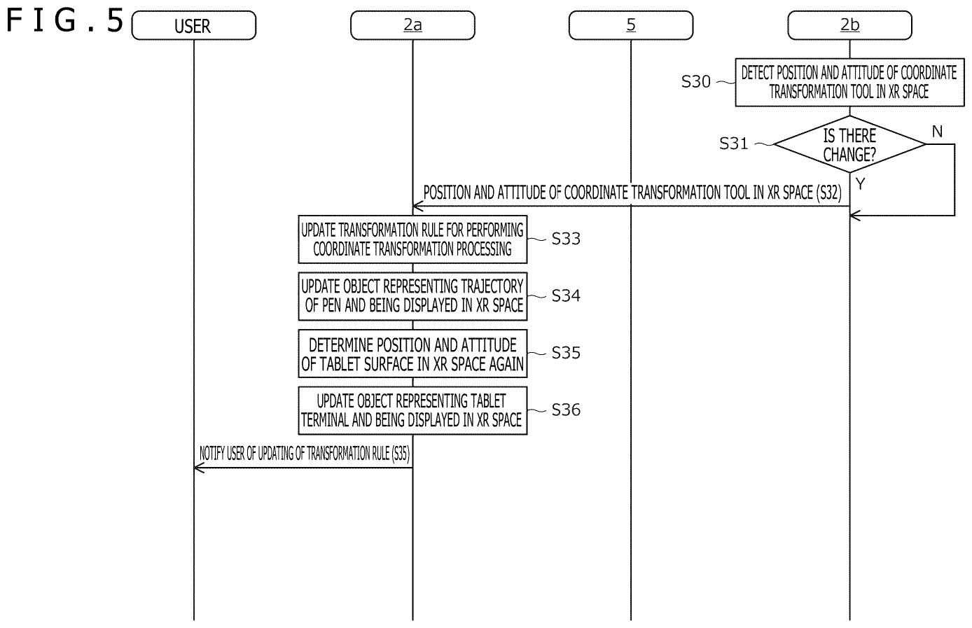

FIG. 5 is a sequence diagram illustrating a process for updating as needed the transformation rule obtained by the process of FIG. 3. The computer 2 needs to perform this process in a case where there is a possibility that the tablet terminal 5 will move after the computer 2 obtains the transformation rule, for example, in a case where the user holds the tablet terminal 5 in a hand as illustrated in FIG. 1.

The XR tracking system 2b operating in the normal operation mode periodically detects the position and attitude of the coordinate transformation tool T1 in the XR space (step S30). A detecting method may be similar to that in step S7 in FIG. 3. Then, the XR tracking system 2b compares the detected position and attitude with the previously detected position and attitude to determine whether there is a change (step S31). When there is no change found as a result of the comparison, the XR tracking system 2b performs no particular process. When there is a change, in contrast, the XR tracking system 2b transmits a six-dimensional vector in the virtual reality space coordinate system which indicates the detected position and attitude, to the computing processor 2a (step S32). Incidentally, the computing processor 2a may instead perform the determination in step S31. In such a case, it is sufficient if the XR tracking system 2b transmits the six-dimensional vector in the virtual reality space coordinate system which indicates the detected position and attitude, to the computing processor 2a at all times.

When receiving the six-dimensional vector in the virtual reality space coordinate system which indicates the position and attitude of the coordinate transformation tool T1 from the XR tracking system 2b in step S32, the computing processor 2a updates the transformation rule for mutually transforming the tablet surface coordinate system and the virtual reality space coordinate system, on the basis of the received six-dimensional vector and the six-dimensional vector in the tablet surface coordinate system which indicates the position and attitude of the coordinate transformation tool T1 read in step S11 in FIG. 3 (step S33). Specifically, it is sufficient to calculate a rotation matrix for transforming the six-dimensional vector read in step S11 into the six-dimensional vector received in step S32 and obtain the rotation matrix again as the transformation rule.

After updating the transformation rule, the computing processor 2a updates the object representing the trajectory of the pen 6 and being displayed in the XR space (step S34). Specifically, it is sufficient to update the six-dimensional vector in the virtual reality space coordinate system which corresponds to a representative position of the object (e.g., the position of a starting point of first stroke data), according to the new transformation rule, and update the display of the object as a whole on the basis of the updated representative position.

In addition, the computing processor 2a determines the position and attitude of the tablet surface 5a in the XR space again on the basis of the position and attitude of the coordinate transformation tool T1 with respect to the tablet surface 5a which are read in step S11 in FIG. 3 and the position and attitude of the coordinate transformation tool T1 in the XR space which are received in step S32 (step S35). Then, the computing processor 2a updates the object representing the tablet terminal 5 and being displayed in the XR space, on the basis of the position and attitude of the tablet surface 5a determined again in step S35 (step S36).

When the processing thus far is ended, the computing processor 2a may notify the user of the updating of the transformation rule (step S35). This notification allows the user to know that the processing according to the movement of the tablet terminal 5 is performed properly.

As described above, according to the XR system 1 of the present embodiment, the computer 2 can obtain the transformation rule for mutually transforming the tablet surface coordinate system and the virtual reality space coordinate system, on the basis of the position and attitude of the coordinate transformation tool T1 included in the images captured by the plurality of cameras 4. Hence, it is possible to implement calibration by an inexpensive coordinate transformation tool as compared with a case of using a light receiving sensor as a coordinate transformation tool as in Patent Document 1.

In addition, according to the XR system 1 of the present embodiment, the two-dimensional code C is provided to the coordinate transformation tool T1, and therefore, the computer 2 can obtain the position and attitude of the coordinate transformation tool T1 included in the images, on the basis of the position and shape of the two-dimensional code C.

Incidentally, in the present embodiment, the description has been made supposing that the user affixes the coordinate transformation tool T1 to the top surface of the tablet terminal 5 at a known position in a known orientation. However, it is often difficult to affix the coordinate transformation tool T1 manually without displacement. Accordingly, a fixture may be used to fix the coordinate transformation tool to the top surface of the tablet terminal 5 more easily.

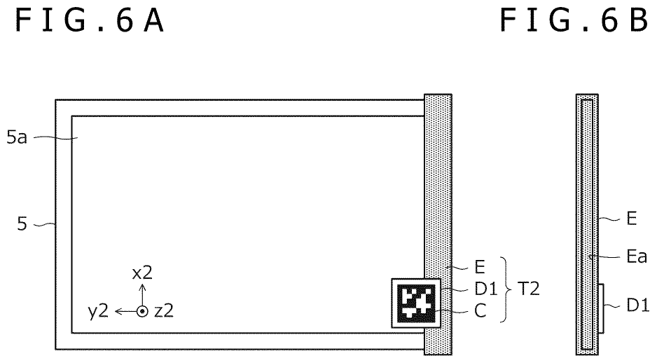

FIG. 6A is a top view of a coordinate transformation tool T2 according to a modification of the present embodiment. FIG. 6B is a side view of the coordinate transformation tool T2 according to the present modification. FIG. 6A also illustrates the tablet terminal 5. The coordinate transformation tool T2 according to the present modification is different from the coordinate transformation tool T1 according to the present embodiment in that the coordinate transformation tool T2 includes a fixture E for fixing the coordinate transformation tool T2 to the tablet terminal 5, in addition to the same casing D1 and two-dimensional code C as those of the coordinate transformation tool T1 according to the present embodiment. The casing D1 is fixed to a surface of the fixture E in advance.

The shape of the fixture E is not particularly limited. The fixture E illustrated in FIGS. 6A and 6B has an insertion cavity Ea into which a short side of the tablet terminal 5 can be fitted. The user can thereby easily fix the coordinate transformation tool T2 to the top surface of the tablet terminal 5 at a known position in a known orientation by merely fitting the tablet terminal 5 into the insertion cavity Ea.

A description will next be made of an XR system 1 according to a second embodiment of the present disclosure. The XR system 1 according to the present embodiment is different from the XR system 1 according to the first embodiment in that the coordinate transformation tool includes a position indicator and that the tablet terminal 5 detects the position and attitude of the coordinate transformation tool. Incidentally, in the present embodiment, a description will be made supposing that the tablet terminal 5 supports the EMR system. The XR system 1 according to the present embodiment is otherwise similar to the XR system 1 according to the first embodiment. Thus, in the following, the description will be continued focusing on differences from the XR system 1 according to the first embodiment.

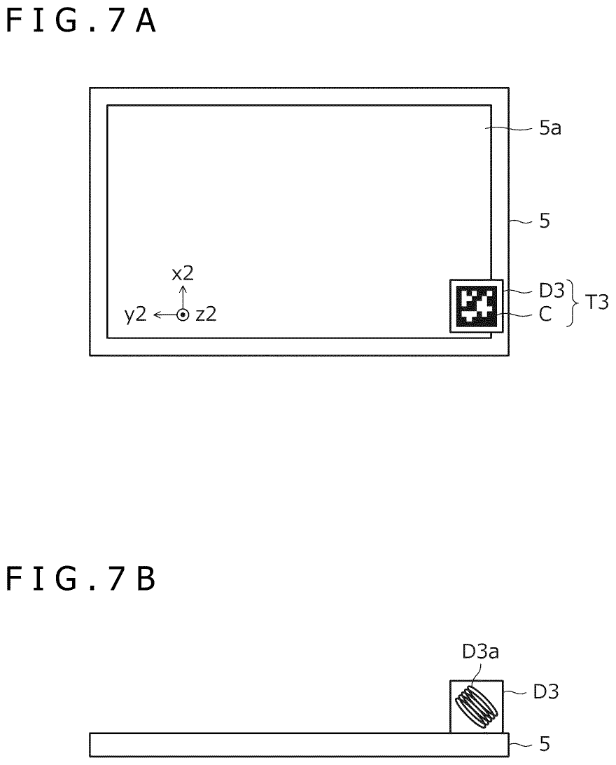

FIG. 7A is a top view of the tablet terminal 5 and a coordinate transformation tool T3 according to the present embodiment. FIG. 7B is a side view of the tablet terminal 5 and the coordinate transformation tool T3 according to the present embodiment. As illustrated in FIG. 7A, as with the coordinate transformation tool T1 according to the first embodiment, the coordinate transformation tool T3 according to the present embodiment includes a box-shaped casing D3 and a two-dimensional code C that is disposed on the top surface of the casing D3. On the other hand, as illustrated in FIG. 7B, the coordinate transformation tool T3 according to the present embodiment further includes an EMR-type position indicator D3a within the casing D3.

Specifically, the position indicator D3a is a circuit including an LC resonant circuit including a coil and a capacitor connected in series with each other. As in the processing described above with regard to detection of the position of the pen 6, the tablet terminal 5 detects the position of the position indicator D3a (that is, the position of the coordinate transformation tool T3) on the tablet surface 5a.

In addition, the tablet terminal 5 is configured to detect also the attitude (amount of rotation about the z2 axis) of the coordinate transformation tool T3 with respect to the tablet surface 5a. In order to enable this detection, the coil constituting the position indicator D3a is disposed within the casing D3 in such a manner as to be inclined with respect to the tablet surface 5a when the coordinate transformation tool T3 is fixed to the tablet surface 5a. The tablet terminal 5 is configured to detect the amount of rotation of the coordinate transformation tool T3 about the z2 axis on the basis of a distribution of detected strength, on the tablet surface 5a, of an alternating magnetic field sent out by the position indicator D3a.

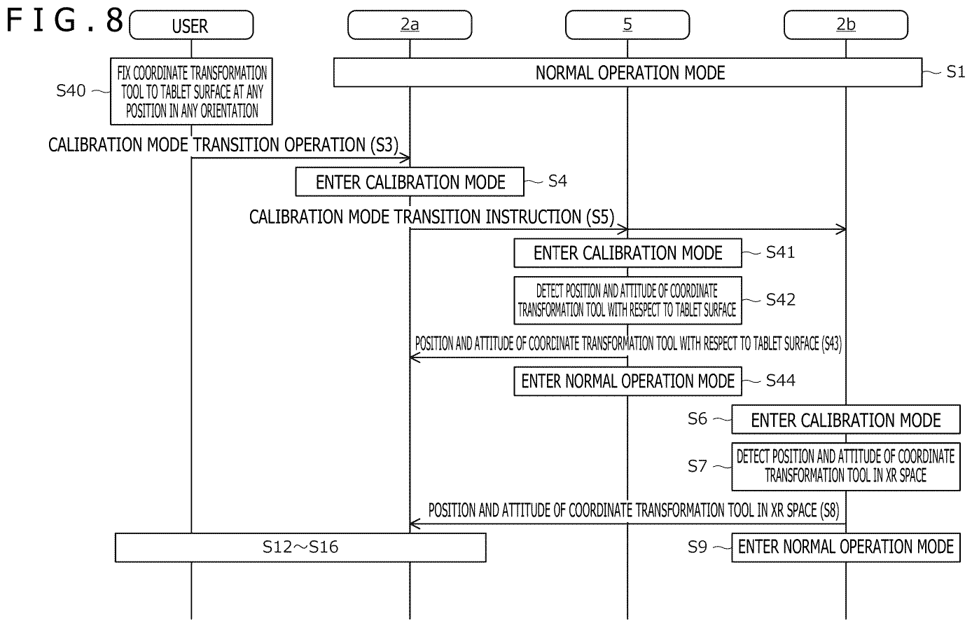

FIG. 8 is a sequence diagram illustrating a process for the computer 2 according to the present embodiment to obtain the transformation rule. In the following, a description will be made focusing on differences from the process illustrated in FIG. 3.

In the present embodiment, the user fixes the coordinate transformation tool T3 to the tablet surface 5a at any position in any orientation (such that the two-dimensional code C is located on the upper surface) (step S40) and thereafter performs a predetermined operation for causing the computing processor 2a to make a transition to the calibration mode (step S3).

In step S5, the computing processor 2a according to the present embodiment transmits a calibration mode transition instruction to not only the XR tracking system 2b but also the tablet terminal 5. Processing performed by the XR tracking system 2b that has received the calibration mode transition instruction is similar to that in the example of FIG. 3 (steps S6 to S9). Meanwhile, the tablet terminal 5 that has received the calibration mode transition instruction enters the calibration mode (step S41) and detects the position and attitude of the coordinate transformation tool T3 with respect to the tablet surface 5a (step S42). A concrete method for this detection is as described above. The tablet terminal 5 transmits a six-dimensional vector in the tablet surface coordinate system which indicates the detected position and attitude, to the computing processor 2a (step S43), and returns to the normal operation mode (step S44). Incidentally, it is sufficient if the tablet terminal 5 sets plane coordinates indicating the detected position of the coordinate transformation tool T3, as an x2 coordinate and a y2 coordinate that are the elements of the six-dimensional vector transmitted in step S43, sets the detected amount of rotation of the coordinate transformation tool T3 about the z2 axis as an amount of rotation about the z2 axis, and sets zero as each of a z2 coordinate, an amount of rotation about the x2 axis, and an amount of rotation about the y2 axis.

After receiving the six-dimensional vector in the tablet surface coordinate system which indicates the position and attitude of the coordinate transformation tool T3 with respect to the tablet surface 5a in step S43 and receiving the six-dimensional vector in the virtual reality space coordinate system which indicates the position and attitude of the coordinate transformation tool T3 in the XR space in step S8, the computing processor 2a performs processing similar to the processing of steps S12 to S16 illustrated in FIG. 3. In this case, the computing processor 2a uses the six-dimensional vector in the tablet surface coordinate system which is received in step S43, in place of the six-dimensional vector in the tablet surface coordinate system which is read in step S11. Thus, the transformation rule for performing the coordinate transformation processing is calculated, and the object representing the tablet terminal 5 is displayed in the XR space.

As described above, also according to the XR system 1 of the present embodiment, the computer 2 can obtain the transformation rule for performing the coordinate transformation processing, on the basis of the position and attitude of the coordinate transformation tool T3 included in the images captured by the plurality of cameras 4. Hence, it is possible to implement calibration by an inexpensive coordinate transformation tool as compared with the case of using a light receiving sensor as a coordinate transformation tool as in Patent Document 1.

In addition, also according to the XR system 1 of the present embodiment, the two-dimensional code C is provided to the coordinate transformation tool T3, and therefore, the computer 2 can obtain the position and attitude of the coordinate transformation tool T3 included in the images, on the basis of the position and shape of the two-dimensional code C.

Further, according to the XR system 1 of the present embodiment, the position indicator D3a is disposed within the coordinate transformation tool T3, and therefore, the user can fix the coordinate transformation tool T3 to the tablet surface 5a at any position in any orientation. Hence, it is possible to reduce a user burden related to the coordinate transformation tool.

Incidentally, also in the present embodiment, the computer 2 preferably performs a process similar to the update process illustrated in FIG. 5. In this update process, it is sufficient if the computer 2 uses the six-dimensional vector in the tablet surface coordinate system which indicates the position and attitude of the coordinate transformation tool T3 received in step S43 in FIG. 8, in place of the six-dimensional vector in the tablet surface coordinate system which indicates the position and attitude of the coordinate transformation tool T1 read in step S11 in FIG. 3.

In addition, while, in the present embodiment, the description has been made of an example in which, in order to enable the tablet terminal 5 to detect the attitude (amount of rotation about the z2 axis) of the coordinate transformation tool T3, the coil constituting the position indicator D3a is disposed within the casing D3 in such a manner as to be inclined with respect to the tablet surface 5a when the coordinate transformation tool T3 is fixed to the tablet surface 5a, another method also enables the tablet terminal 5 to detect the attitude (amount of rotation about the z2 axis) of the coordinate transformation tool.

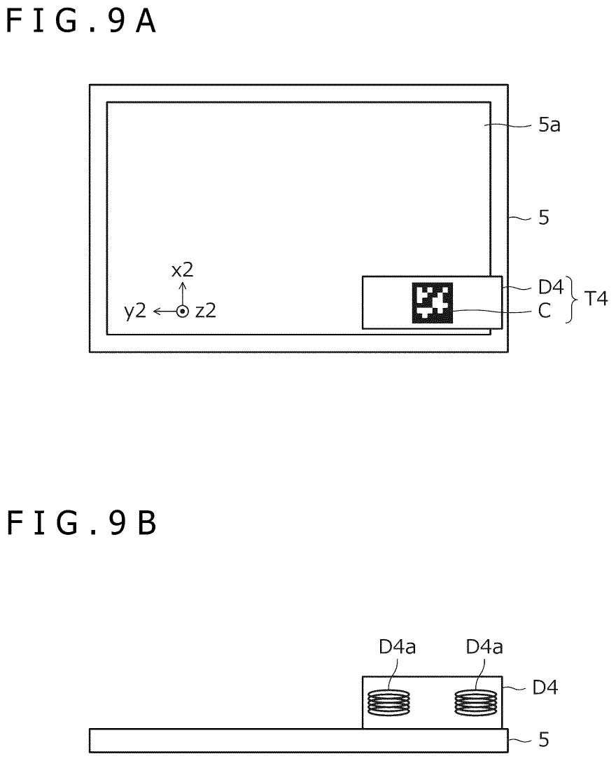

FIG. 9A is a top view of the tablet terminal 5 and a coordinate transformation tool T4 according to a first modification of the present embodiment. FIG. 9B is a side view of the tablet terminal 5 and the coordinate transformation tool T4 according to the present modification. As illustrated in FIGS. 9A and 9B, the coordinate transformation tool T4 is similar to the coordinate transformation tool T3 according to the present embodiment in that the coordinate transformation tool T4 includes a box-shaped casing D4 and a two-dimensional code C disposed on the top surface of the casing D4. However, the coordinate transformation tool T4 is different from the coordinate transformation tool T3 according to the present embodiment in that the casing D4 is more elongated than the casing D3.

In addition, as illustrated in FIG. 9B, two EMR-type position indicators D4a are arranged within the casing D4. Each of the position indicators D4a is similar to the position indicator D3a in that the position indicator D4a is formed by a circuit including an LC resonant circuit including a coil and a capacitor connected in series with each other, but is different from the position indicator D3a in that each coil is disposed within the casing D4 in such a manner as to be horizontal with respect to the tablet surface 5a when the coordinate transformation tool T4 is fixed to the tablet surface 5a. As illustrated in FIG. 9B, the coils of the respective position indicators D4a are arranged at a certain distance from each other in a direction parallel with the tablet surface 5a.

The tablet terminal 5 according to the present modification is configured to detect the position of the coordinate transformation tool T4 on the tablet surface 5a and detect the attitude (amount of rotation about the z2 axis) of the coordinate transformation tool T4 with respect to the tablet surface 5a by detecting the respective positions of the two position indicators D4a included in the coordinate transformation tool T4. Thus, also according to the present modification, as in the present embodiment, the computer 2 can obtain the transformation rule for performing the coordinate transformation processing.

In addition, while, in the present embodiment, the description has been made of a case where the tablet terminal 5 supports pen input by the EMR system, effects similar to those of the present embodiment can be obtained also in cases where the tablet terminal 5 supports pen input by another system.

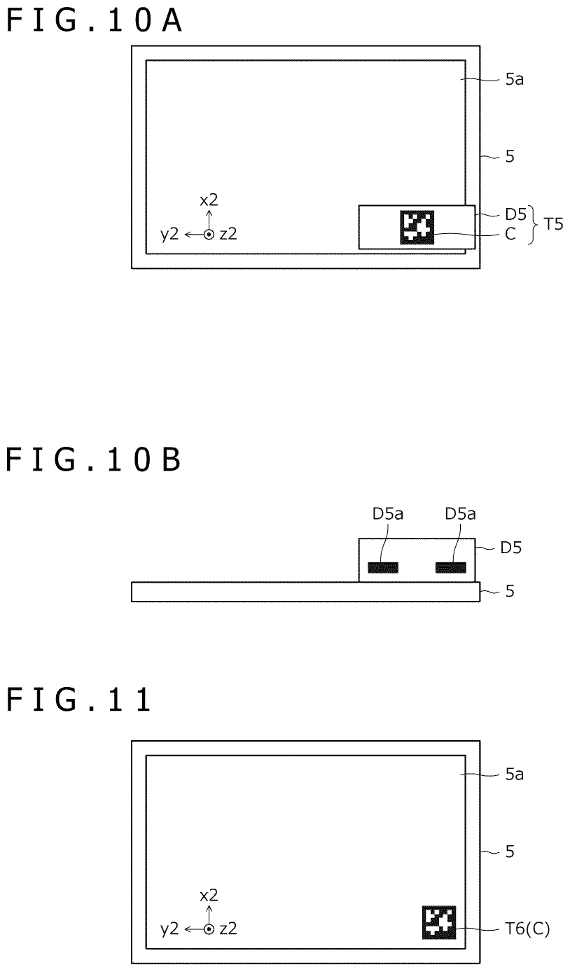

FIG. 10A is a top view of the tablet terminal 5 and a coordinate transformation tool T5 according to a second modification of the present embodiment. FIG. 10B is a side view of the tablet terminal 5 and the coordinate transformation tool T5 according to the present modification. In the present modification, a description will be made of a case where the tablet terminal 5 supports the active capacitive system.

The coordinate transformation tool T5 according to the present modification is similar to that of the coordinate transformation tool T4 according to the first modification of the present embodiment in that the coordinate transformation tool T5 includes an elongated box-shaped casing D5 and a two-dimensional code C disposed on the top surface of the casing D5. However, the coordinate transformation tool T5 is different from the coordinate transformation tool T4 according to the first modification of the present embodiment in that, in place of the two position indicators D4a, two position indicators D5a each supporting the active capacitive system are arranged within the casing D5.

Each of the position indicators D5a specifically includes the above-described pen tip electrode, processing circuit, and battery. Incidentally, the two position indicators D5a may share the processing circuit and the battery. As illustrated in FIG. 10B, the pen tip electrodes of the respective position indicators D5a are arranged at a certain distance from each other in a direction parallel with the tablet surface 5a.

The tablet terminal 5 according to the present modification is configured to detect the position of the coordinate transformation tool T5 on the tablet surface 5a and detect the attitude (amount of rotation about the z2 axis) of the coordinate transformation tool T5 with respect to the tablet surface 5a by detecting the respective positions of the two position indicators D5a included in the coordinate transformation tool T5. Thus, also according to the present modification, as in the present embodiment and the first modification, the computer 2 can obtain the transformation rule for performing the coordinate transformation processing.

An XR system 1 according to a third embodiment of the present disclosure will next be described. The XR system 1 according to the present embodiment is different from the XR system 1 according to the second embodiment in that the coordinate transformation tool is constituted by an image displayed on the tablet surface 5a. The XR system 1 according to the present embodiment is otherwise similar to the XR system 1 according to the second embodiment. Thus, in the following, the description will be continued focusing on differences from the XR system 1 according to the second embodiment.

FIG. 11 is a top view of the tablet terminal 5 and a coordinate transformation tool T6 according to the present embodiment. As illustrated in FIG. 11, the coordinate transformation tool T6 according to the present embodiment is constituted by a two-dimensional code C displayed on the tablet surface 5a. Because the coordinate transformation tool T6 is displayed by the tablet terminal 5, the tablet terminal 5 can obtain plane coordinates indicating the display position of the coordinate transformation tool T6 on the tablet surface 5a and an amount of rotation of the coordinate transformation tool T6 about the z2 axis.

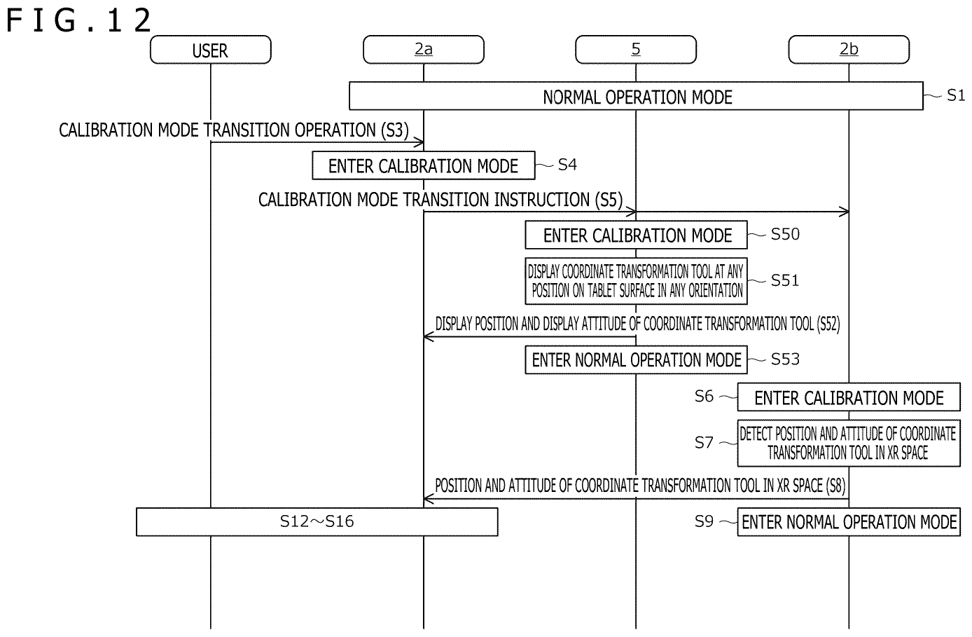

FIG. 12 is a sequence diagram illustrating a process for the computer 2 according to the present embodiment to obtain the transformation rule. In the following, a description will be made focusing on differences from the process illustrated in FIG. 8.

In the present embodiment, the user first performs a predetermined operation for causing the computing processor 2a to make a transition to the calibration mode (step S3). The process performed by the computing processor 2a and the XR tracking system 2b in response to this operation is similar to that described with reference to FIG. 8.

When the tablet terminal 5 according to the present embodiment receives the calibration mode transition instruction from the computing processor 2a (step S5), the tablet terminal 5 enters the calibration mode (step S50) and displays the coordinate transformation tool T6 as a two-dimensional code C at any position on the tablet surface 5a (step S51). Then, the tablet terminal 5 transmits a six-dimensional vector in the tablet surface coordinate system which indicates the display position and display attitude of the coordinate transformation tool T6, to the computing processor 2a (step S52), and returns to the normal operation mode (step S53). Incidentally, it is sufficient if the tablet terminal 5 sets the plane coordinates indicating the display position of the coordinate transformation tool T6, as an x2 coordinate and a y2 coordinate that are the elements of the six-dimensional vector transmitted in step S52, sets the amount of rotation of the coordinate transformation tool T6 about the z2 axis as an amount of rotation about the z2 axis, and sets zero as the value of each of a z2 coordinate, an amount of rotation about the x2 axis, and an amount of rotation about the y2 axis.

After receiving the six-dimensional vector in the tablet surface coordinate system which indicates the display position and display attitude of the coordinate transformation tool T6 in step S52 and receiving the six-dimensional vector in the virtual reality space coordinate system which indicates the position and attitude of the coordinate transformation tool T6 in the XR space in step S8, the computing processor 2a performs processing similar to the processing of steps S12 to S16 illustrated in FIG. 3. Thus, the transformation rule for performing the coordinate transformation processing is calculated, and the object representing the tablet terminal 5 is displayed in the XR space.

As described above, also according to the XR system 1 of the present embodiment, the computer 2 can obtain the transformation rule for performing the coordinate transformation processing, on the basis of the position and attitude of the coordinate transformation tool T6 included in the images captured by the plurality of cameras 4. Hence, it is possible to implement calibration by an inexpensive coordinate transformation tool as compared with the case of using a light receiving sensor as a coordinate transformation tool as in Patent Document 1.

In addition, according to the XR system 1 of the present embodiment, the coordinate transformation tool T6 is constituted by the two-dimensional code C displayed on the tablet surface 5a, and therefore, the computer 2 can obtain the position and attitude of the coordinate transformation tool T6 included in the images, on the basis of the position and shape of the two-dimensional code C. In addition, because the user does not need to physically handle the coordinate transformation tool T6, it is possible to reduce a user burden related to the coordinate transformation tool.

Incidentally, in the present embodiment, the description has been made of an example in which the tablet terminal 5 transmits the six-dimensional vector in the tablet surface coordinate system to the computing processor 2a in step S52. In a case where the display attitude (amount of rotation about the z2 axis) of the coordinate transformation tool T6 is determined in advance, the tablet terminal 5 may alternatively transmit only the plane coordinates indicating the display position of the coordinate transformation tool T6 to the computing processor 2a. In this case, it is sufficient if the computing processor 2a obtains the six-dimensional vector in the tablet surface coordinate system which indicates the display position and display attitude of the coordinate transformation tool T6, by generating the six-dimensional vector in the tablet surface coordinate system from the received plane coordinates.

The preferred embodiments of the present disclosure have been described above. However, the present disclosure is not at all limited to such embodiments, and it is obvious that the present disclosure can be carried out in various modes without departing from the spirit of the present disclosure.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A calibration method performed by a computer, the method comprising:
calculating, based on a position and an attitude of a coordinate transformation tool included in an image captured of the coordinate transformation tool located on a surface of an apparatus including a digitizer, a transformation rule for performing coordinate transformation processing that transforms first coordinates specifying a position, on the surface and indicated by a stylus, into second coordinates specifying a position in an extended reality space.

2. The calibration method according to claim 1, wherein
the coordinate transformation tool includes a two-dimensional code, and
the position and the attitude of the coordinate transformation tool are detected based on a position and a shape of the two-dimensional code included in the image.

3. The calibration method according to claim 1, wherein
the coordinate transformation tool includes a position indicator configured to enable the apparatus including the digitizer to detect a position and an attitude of the position indicator with respect to the surface, and
the computer receives information indicating the position and the attitude of the position indicator with respect to the surface, and
calculates the transformation rule for performing the coordinate transformation processing, based on the received information indicating the position and the attitude of the position indicator with respect to the surface.

4. The calibration method according to claim 3, wherein
the apparatus including the digitizer obtains the information indicating the position and the attitude of the position indicator with respect to the surface by detecting an alternating magnetic field sent out by the position indicator.

5. The calibration method according to claim 3, wherein
the apparatus including the digitizer obtains the information indicating the position and the attitude of the position indicator with respect to the surface by detecting a downlink signal transmitted by the position indicator.

6. The calibration method according to claim 1, further comprising
receiving coordinates indicating a display position of the coordinate transformation tool displayed on the surface, and
calculating the transformation rule for performing the coordinate transformation processing based on the received coordinates indicating the display position of the coordinate transformation tool.

7. A calibration method performed by a computer, the method comprising:
receiving information indicating a position and an attitude of a coordinate transformation tool with respect to a surface of an apparatus including a digitizer; and
calculating a transformation rule for performing coordinate transformation processing that transforms first coordinates specifying a position, on the surface and indicated by a stylus, into second coordinates specifying a position in an extended reality space based on the received information indicating the position and the attitude of the coordinate transformation tool with respect to the surface and a position and an attitude of the coordinate transformation tool in the extended reality space.

8. The calibration method according to claim 7, wherein
the coordinate transformation tool includes a position indicator configured to enable the apparatus including the digitizer to detect a position and an attitude of the position indicator with respect to the surface, and
the information indicating the position and the attitude of the coordinate transformation tool with respect to the surface is information indicating the position and the attitude of the position indicator with respect to the surface that are detected by the apparatus including the digitizer.

9. The calibration method according to claim 8, wherein
the apparatus including the digitizer obtains the information indicating the position and the attitude of the position indicator with respect to the surface by detecting an alternating magnetic field sent out by the position indicator.

10. The calibration method according to claim 9, wherein
the position indicator includes a coil inclined with respect to the apparatus including the digitizer when the coordinate transformation tool is fixed to the surface.

11. The calibration method according to claim 9, wherein
the coordinate transformation tool includes a plurality of position indicators.

12. The calibration method according to claim 8, wherein
the apparatus including the digitizer obtains the information indicating the position and the attitude of the position indicator with respect to the surface by detecting a downlink signal transmitted by the position indicator.

13. The calibration method according to claim 12, wherein
the coordinate transformation tool includes a plurality of position indicators.

14. The calibration method according to claim 7, wherein
the coordinate transformation tool includes a two-dimensional code, and
the computer captures an image of the two-dimensional code and detects the position and the attitude of the coordinate transformation tool on based on a position and a shape of the two-dimensional code included in the captured image.

15. A calibration method performed by a computer, the method comprising:
receiving coordinates indicating a display position of a coordinate transformation tool on a surface of an apparatus including a digitizer; and
calculating a transformation rule for performing coordinate transformation processing that transforms first coordinates specifying a position, on the surface and indicated by a stylus, into second coordinates specifying a position in an extended reality space, based on the received coordinates indicating the display position of the coordinate transformation tool on the surface and a position and an attitude of the coordinate transformation tool in the extended reality space.

16. The calibration method according to claim 15, wherein
the coordinate transformation tool includes a two-dimensional code, and
the computer captures an image of the two-dimensional code and detects the position and the attitude of the coordinate transformation tool on a basis of a position and a shape of the two-dimensional code included in the captured image.

17. A coordinate transformation tool for use by a computer, the coordinate transformation tool comprising:
a two-dimensional code,
the computer being configured to calculate, based on a position and a shape of the two-dimensional code included in an image captured of the coordinate transformation tool fixed to a surface of an apparatus including a digitizer, a transformation rule for performing coordinate transformation processing that transforms first coordinates specifying a position, on the surface and indicated by a stylus, into second coordinates specifying a position in an extended reality space.

18. A coordinate transformation tool for use by a computer, the coordinate transformation tool comprising:
a position indicator configured to enable an apparatus including a digitizer to detect a position and an attitude of the position indicator with respect to a surface of the apparatus,
the computer being configured to calculate a transformation rule for performing coordinate transformation processing, based on the position and the attitude of the position indicator with respect to the surface that are detected by the apparatus including the digitizer.

19. The coordinate transformation tool according to claim 18, further comprising:
a two-dimensional code, wherein the computer calculates the transformation rule for performing the coordinate transformation processing, based on a position and a shape of the two-dimensional code included in an image captured of the coordinate transformation tool.

20. A coordinate transformation tool for use by a computer, the coordinate transformation tool comprising:
an image displayed on a surface of an apparatus including a digitizer,
the computer being configured to obtain a transformation rule for performing coordinate transformation processing that transforms first coordinates specifying a position, on the surface and indicated by a stylus, into second coordinates specifying a position in an extended reality space, based on coordinates indicating a display position of the image displayed on the surface.

21. The coordinate transformation tool according to claim 20, wherein
the image includes a two-dimensional code, and
the computer obtains the transformation rule for performing the coordinate transformation processing, based on a position and a shape of the two-dimensional code included in an image captured of the coordinate transformation tool.
